(19) United States
(12) Patent Application Publication
(10) Pub. No.: US 2019/0226215 A1
(43) Pub. Date: Jul. 25, 2019

(54) Pattern Tile

(71) Applicant: Daniel Selton, Alpharetta, GA (US)

(72) Inventor: Daniel Selton, Alpharetta, GA (US)

(21) Appl. No.: 15/879,648

(22) Filed: Jan. 25, 2018

(51) Int. Cl. E04F 15/08; E04F 13/14; B44C 1/28; A63B 69/36

(52) U.S. Cl. CPC E04F 15/08; E04F 13/14; A63B 2102/32; A63B 69/3661; B44C 1/28

(57) ABSTRACT

A pattern tile set is provided having a first tile and a second tile. The first tile comprises of a first tile portion defined by an arcuate shape with a second portion defining a background. The arcuate shape has a first color tone and the second portion has a second color tone. A second tile which is the negative of the first tile has an arcuate shape of the same size and shape as the arcuate portion of the first tile and a color tone identical to the background of the first tile. The back ground of the second tile has a color tone identical to the arcuate profile of the first tile.

### TECHNICAL FIELD

This invention relates generally to patterned tiles and more particularly to patterned tiles that cooperatively define a floor covering in which a contrast pattern of a given tile in conjunction with the negatively contrast pattern of an adjacent tile achieves a desired visual appearance.

### BACKGROUND OF THE INVENTION

Conventional tile is usually produced to provide an overall consistent pattern design. For instance, conventional carpet tiles have historically been a product sought to appear like a larger tufted carpet and hide the fact that it was modular in design. Such construction leads to a uniform shape and appearance that presents a uniform floor covering when the tiles are positioned next to one another. Also, some more recent tile designs have been constructed such that any rotational positioning of the tiles produce a similar overall visual effect when installed.

There is a need for modular floor designs that are not restricted to a single, consistent overall appearance. Consequently, there is a need for modular flooring tiles that cooperate to produce varying visual effects depending on the positioning of the respective tiles. Also, there is a need for a customization tool which enables an end user to produce a floor covering design.

### SUMMARY OF THE INVENTION

To provide for a more aesthetic floor covering one embodiment includes a plurality of tiles. The invention includes a tile set having a first tile with a predefined surface area. The first tile includes a predefined surface area having a first tile portion having a first color tone appearance and a second tile portion having a second color tone appearance. The first and second tile portions constituting the entire surface area of the first tile. The first tile portion has an arcuate profile and the first color tone extends throughout the entire area enclosed by the arcuate profile. The second tile portion encompasses the remainder of the first tile defining a background and the second color tone is of a distinctive tone than the first color tone of the first portion. A second tile is included having a predefined surface area. The second tile predefined surface area has a first tile portion having a first color tone appearance and a second tile portion having a second color tone appearance. The first and second portion constituting the entire surface area of the second tile. The first tile portion having an arcuate profile and the first color tone extending throughout the entire area enclosed by the arcuate profile. The second tile portion encompasses the remainder of the second tile defining a background and the second color tone being of a distinctive tone than the first color tone of the first portion, whereas the first color tone of the first tile portion of the first tile being the same color tone as the second tile portion of the second tile and the second color tone of the second tile portion of the second tile being the same color tone as the first tile portion of the first tile.

In a second embodiment, the invention includes a tile set including a first tile having a predefined surface area. The first tile includes a predefined surface area having a first tile portion having a first color tone appearance and a second tile portion having a second color tone appearance. The first and second tile portions constituting the entire surface area of the first tile. The first tile portion has an arcuate profile and the first color tone extends throughout the entire area enclosed by the arcuate profile. The second tile portion encompasses the remainder of the first tile defining a background and the second color tone is of a tone distinctive from the first color tone of the first portion. A second tile is included having a predefined surface area. The second tile predefined surface area has a first tile portion having a first color tone appearance and a second tile portion having a second color tone appearance. The first and second portion constituting the entire surface area of the second tile. The first tile portion having an arcuate profile and the first color tone extending throughout the entire area enclosed by the arcuate profile. The second tile portion encompasses the remainder of the second tile defining a background and the second color tone being of a tone distinctive from the first color tone of the first portion, whereas the first color tone of the first tile portion of the first tile being the same color tone as the second tile portion of the second tile and the second color tone of the second tile portion of the second tile being the same color tone as the first tile portion of the first tile. A third tile is provided having a third tile profile and having a color tone which is the same color tone as the first tile portion of the first tile. A fourth tile is provided having a fourth tile profile and having a color tone which is the same color tone as the first tile portion of said second tile.

### BRIEF DESCRIPTION OF THE DRAWINGS

The subject matter which is regarded as the invention is particularly pointed out and distinctly claimed in the claims after the specification. The foregoing and other features, and advantages of the invention are apparent from the following detailed description taken in conjunction with the accompanying drawings in which:

FIG. 1 illustrates a first tile configuration having a primary area and a background area according to the present invention;

FIG. 2 illustrates a second tile configuration having a negative image of the first tile configuration according to the present invention;

FIG. 3 illustrates a tile arrangement which may be developed utilizing the first and second tile configurations of the present invention;

FIG. 4 illustrates a third and fourth tile configuration based on the primary and background areas of the first and second tile configurations of the present invention;

FIG. 5 illustrates a tile arrangement which may be developed utilizing the first, second and third tile configurations of the present invention;

FIG. 6 illustrates a computer system adapted to provide a system for determining a desired floor covering configuration according to the present invention.

FIG. 7 illustrates a method for determining a desired floor covering configuration according to the present invention.

FIG. 8 illustrates a tile arrangement which may be developed utilizing the first, second, third and fourth tile configurations of the present invention;

FIG. 9 illustrates a tile arrangement corresponding to a putting green utilizing the tiles of the present invention.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified as such can, of course, vary. It is also to be understood that the terminology used herein is for describing aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention.

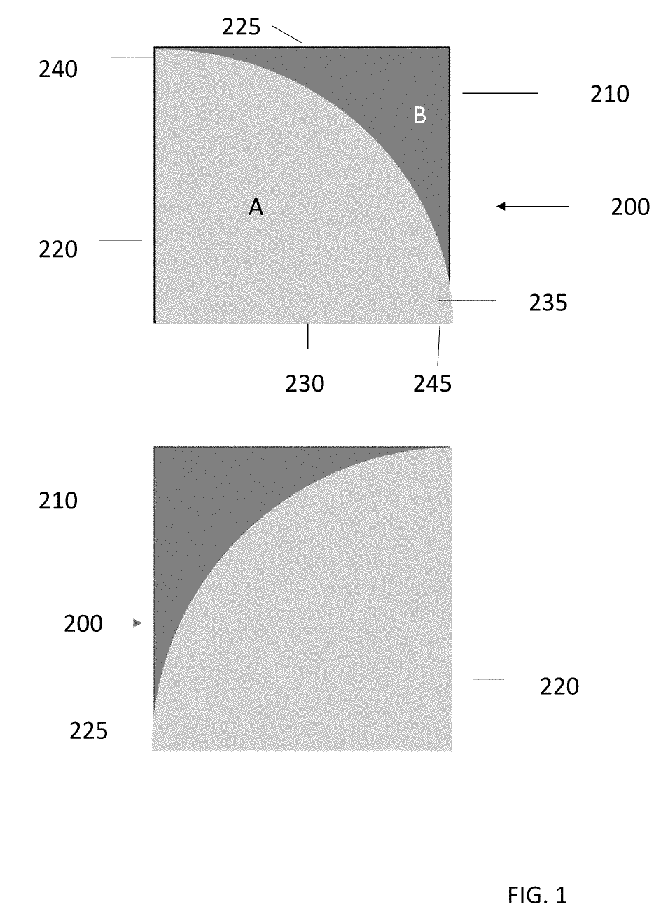

As illustrated in FIG. 1, a first tile 200 is shown has a first position and a second rotated position. As shown in the first position, first tile 200 has a plurality of edges including a top edge 225 and a bottom edge 230 which become a left and right-side edge respectively when rotated in the second position. Edges 225 and 230 are oppositely disposed edges respectively. In some embodiments tile 200 may be substantially rectangular wherein top edge 225 may be greater than a respective side edge. In other embodiments, it is contemplated that the tile be substantially square. In some respects, it is contemplated that the tile is a carpet tile which can have a tufted face, a woven face or a fusion-bonded face that is formed according to conventional methods. The tile may also be non-carpet having a printed face surface. Preferably first tile 200 is a square having a width designated by top edge 225 and bottom edge 230 in the first position and a height designated by the left and right-side edges when in the second position.

As shown in FIG. 1, first tile 200 has two distinct areas within the area defined by the edges. The first area or portion designated 220 is an area preferably representing a shape equating to a quarter of a circle with an arch which extends towards one corner of the tile to the diagonally opposite corner. The shape includes an arc which extends past a diagonal axis established by the offsetting corners. The first portion arc has an upmost top edge 240 and an opposing side edge 245. In the preferred embodiment, the arc runs from the respective edges continuously throughout the body of the tile. The arc may be of different sizes extending past the diagonal formed between the respective edges 240 and 245. In the preferred embodiment notwithstanding the area under the curve as defined by the arc, the edges of the arc preferably only intersect with the horizontal top edge 225 at the corner of the tile and with side edge 235 only at the corner of the tile. The area within the curve profile has a first color tone “A”. In the preferred embodiment, the interior area of the tile which is not represented by the curvilinear shape defines a second portion 210 or background having a second color tone “B”. Preferably, the first area “A” and second area “B: each consist of a single shade of color with the single shade of color of area “A” being distinctive from the single shade of color of second area “B”. As shown in FIG. 1, the entire interior area of the tile consists solely of the first portion 220 of color tone “A” and second portion 210 of color tone “B” with color tone “B” being distinctive and preferably of a darker shade than color tone “A”. Herein the term “darker” refers that the colors are distinguishable. They both may be light colors, such as peach and lime, but they are visually perceivable as being different, such that one would be visually contrasting to the other.

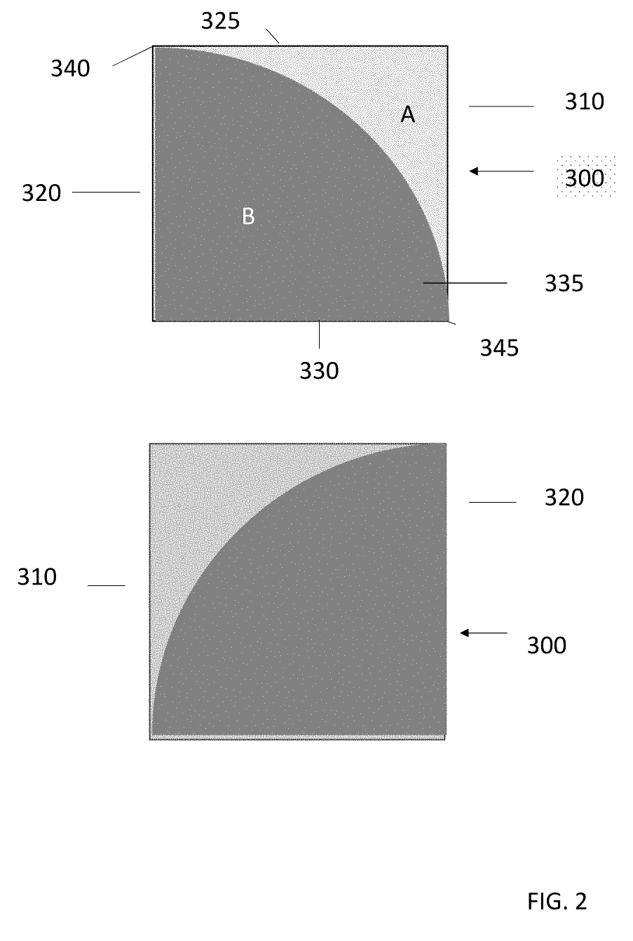

As illustrated in FIG. 2, a second tile 300 is shown in a first position and a second rotated position. As shown in the first position, second tile 300 has a plurality of edges including a top edge 325 and a bottom edge 330 which become a left and right-side edge respectively when rotated in the second position. Edges 325 and 330 have oppositely disposed edges respectively. In some embodiments second tile 300 may be substantially rectangular wherein top edge 325 may be greater than a respective side edge. In other embodiments, it is contemplated that the second tile be substantially square. In some respects, it is contemplated that the tile is a carpet tile which can have a tufted face, a woven face a fusion-bonded face that I formed according to conventional methods. The tile may also be non-carpet having a printed face surface. Preferably second tile 300 is a square having a width designated by top edge 325 and bottom edge 330 in the first position and a height designated by the left and right-side edges when in the second position.

As shown in FIG. 2, second tile 300 has two distinct areas within the area defined by the edges. The first area or portion designated 320 is an area preferably representing a shape equating to a quarter of a circle with an arch which extends from one corner of the tile to the diagonally opposite corner. The shape includes an arc which extends past a diagonal axis established by the offsetting corners. The first portion arc has an upmost top edge 340 and an opposing side edge 345. In the preferred embodiment, the arc runs from the respective edges continuously throughout the body of the tile. The arc may be of different sizes extending past the diagonal formed between the respective edges 340 and 345. In the preferred embodiment notwithstanding the area under the curve as defined by the arc, the edges of the arc preferably only intersect with the horizontal top edge 325 at the corner of the tile and with side edge 335 only at the corner of the tile. The area within the curve profile has a first color tone “B”. In the preferred embodiment, the interior area of the tile which is not represented by the curvilinear shape defines a second portion 230 having a second color tone “A”. Preferably, the first area 320 and second area 310 each consist of a single shade of color with the single shade of color “B” of area 320 being distinctive from and contrasting with the single shade of color “A” of area 310. As shown in FIG. 2, the entire interior area of the tile consists solely of the first portion 320 of color tone “B” and second portion 310 of color tone “A” with color tone “B” being of a darker shade than color tone “A”.

As shown in FIG. 1 and FIG. 2, the respective components of the tiles are identically shaped. The first portion 220 of first tile 200 having a curved profile which preferably resembles a quarter of a circle extending from one corner to the oppositely disposed corner has the identical area and outline of the first portion 320 of second tile 300 having a curved profile which preferably resembles a quarter of a circle extending from one corner to the oppositely disposed corner. In essence, first portion 220 of first tile 200 is identical to first portion 320 of second tile 300. Accordingly, the second portion 210 of first tile 200 which occupies the remainder of the interior surface of first tile 200 is identical to the second portion 310 of the second tile.

A critical feature of the invention is that the respective color tones of the first and second tiles are the same. For example, the first portion 220 of first tile 200 has a first color tone designated as “A”. This same color tone “A” is utilized in the second background portion 310 of the second tile 300. Also, the second portion 210 of first tile 200 has a second color tone designated as “B. This same color tone “B” is utilized in the first portion 320 of the second tile 300. This geometric and color configuration renders the first and second tiles 200 and 300 negatives of each other.

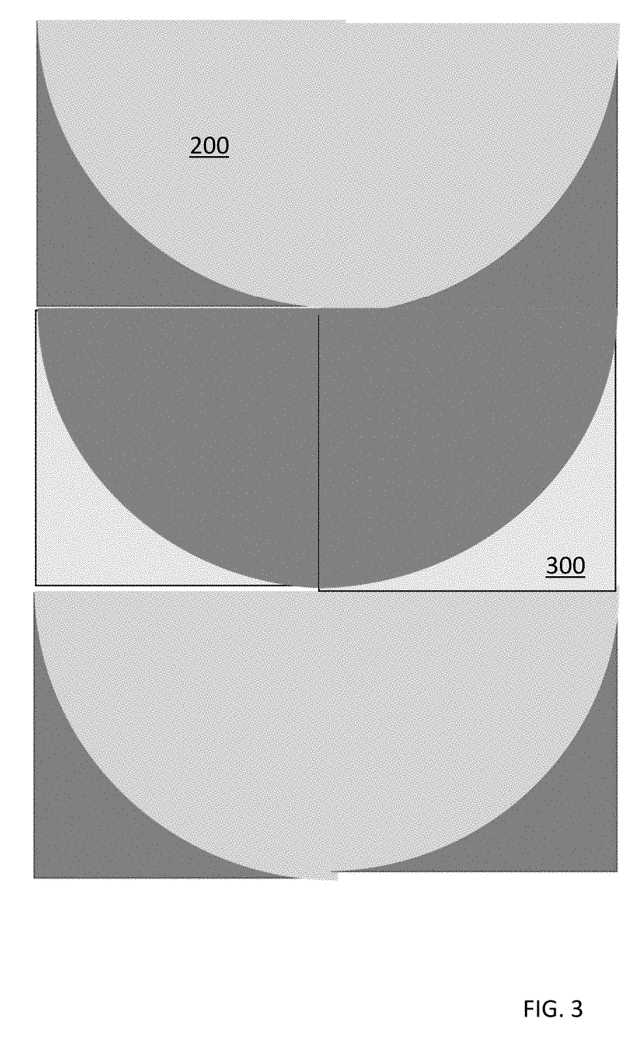

FIG. 3 illustrates a floor covering pattern which may be developed utilizing the first and second tiles constructed according to the invention. The illustrated pattern consists of six tiles, four tile 200 and two tile 300. The arc which traverses a respective tile 200 is aligned with and intersects with the corresponding arc of an abutting tile 200 forming a continuous curved configuration resembling a node defined by the abutting interior first portions having color tone “A” outlined by the darker second portions with color tone “B”. Likewise, a continuous curved configuration resembling a node is defined by the abutting interior first portions of tiles 300.

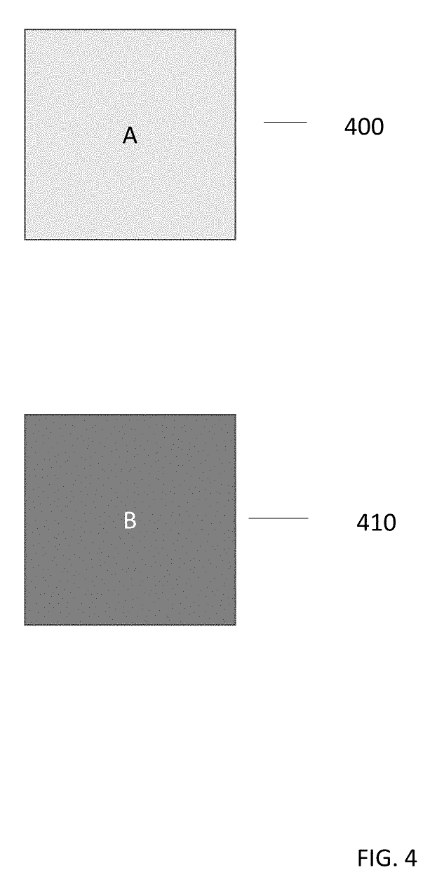

As shown in FIG. 4, to provide for more possible floor covering configurations, additional tiles may be provided to cooperate with first and second tiles 200 and 300 respectively. As shown in FIG. 4, a third tile 400 is provided. Third tile 400 preferably has the same shape as first and second tiles respectively which is preferably square, but may be rectangular and of the same size. However, third tile 400 may be of a larger area to provide a larger cover area. As shown in FIG. 4, third tile 400 is of a solid nature having a single color or shade. Third tile 400 is shown having a shade identical to the shade “A” of the first portion 220 of first tile 200 and second portion 310 of second tile 300. Also, as shown in FIG. 4, a fourth tile 410 may be provided. Fourth tile 410 preferably has the same shape as first and second tiles respectively which is preferably square, but may be rectangular and of the same size. However, fourth tile 410 may be of a larger area to provide a larger cover area. As shown in FIG. 4, fourth tile 410 is of a solid nature having a single color or shade. Fourth tile 410 is shown having a shade identical to the shade “B” of the second portion 210 of first tile 200 and second portion 320 of second tile 300. In this manner, a representative of either third tile 400 or fourth tile 410 may be utilized in combination with first and second tiles 200 and 300 respectively.

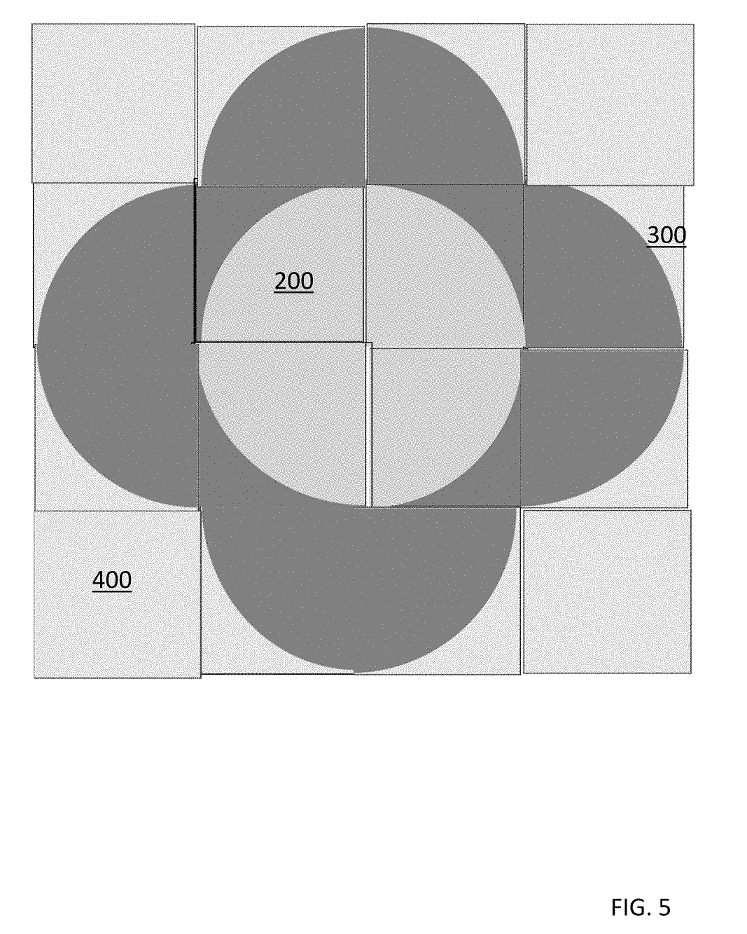

FIG. 5 illustrates a floor covering pattern which may be constructed utilizing first and second tiles 200 and 300 respectively in combination with a single solid tile 400. FIG. 5 illustrates a four by four configuration utilizing four first tiles 200, eight second tiles 300 and four third tiles 400. The four first tiles 200 are arranged such that the four interior first portions 220 of tone “A” abut each other and in this illustration, produces a circle. The eight second tiles abut the eight exterior sides of the interior four first tiles 200 in a manner such that the first portions 320 of the second tiles 300 having tone “B” abut and communicate with the second portions 210 of the first tiles 200 having tone “B in a continuous manner. Also, as shown in FIG. 5, third tile 400 consisting of an interior having tone “A” is utilized to define the four corners of the overall design. The single tone “A” abuts and communicates with the adjacent second portions 310 of second tiles 300 having tone “A” to provide for a continuous design.

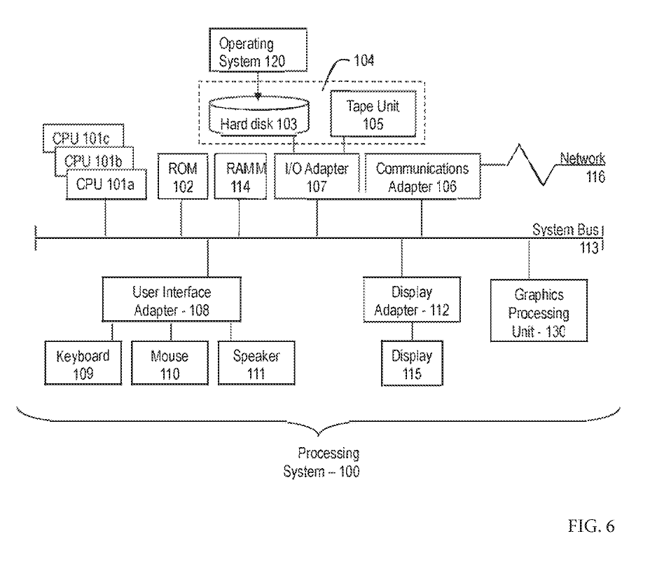

Referring to FIG. 6, there is shown central processing system 100 according to one or more embodiments. The system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 6 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling log management system 100 to communicate with other such systems. A screen (e.g., a display monitor) 115 is connected to system bus 113 by display adaptor 112, which may include a graphics adapter to improve the performance of graphics intensive applications and a video controller. In one or more embodiments, adapters 107, 106, and 112 may be connected to one or more I/O busses that are connected to system bus 113 via an intermediate bus bridge (not shown). Suitable lAbuses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit. A friend repository file 117 is associated with mass storage 104 for storing data records containing information collected from databases 220 and 230. Friend repository file 117 includes a plurality of friend records which identify friends defined within a social network. These friends have identified subject matter which they are interested in and their respective location. The location of the friends may be identified as a general location such as their hometown, or could by dynamically updated via a GPS system associated with their respective user device.

Thus, as configured in FIG. 6, the processing system 100 includes processing capability in the form of processors 101, storage capability including the system memory 114 and mass storage 104, input means such as keyboard 109 and mouse 110, and output capability including speaker 111 and display 115. In one or more embodiments, a portion of system memory 114 and mass storage 104 collectively store an operating system to coordinate the functions of the various components shown in FIG. 6. The processing system 100 may be a phone which utilizes an app running on the processors for providing an interface system for a user to develop a floor covering pattern utilizing the tiles of the present invention.

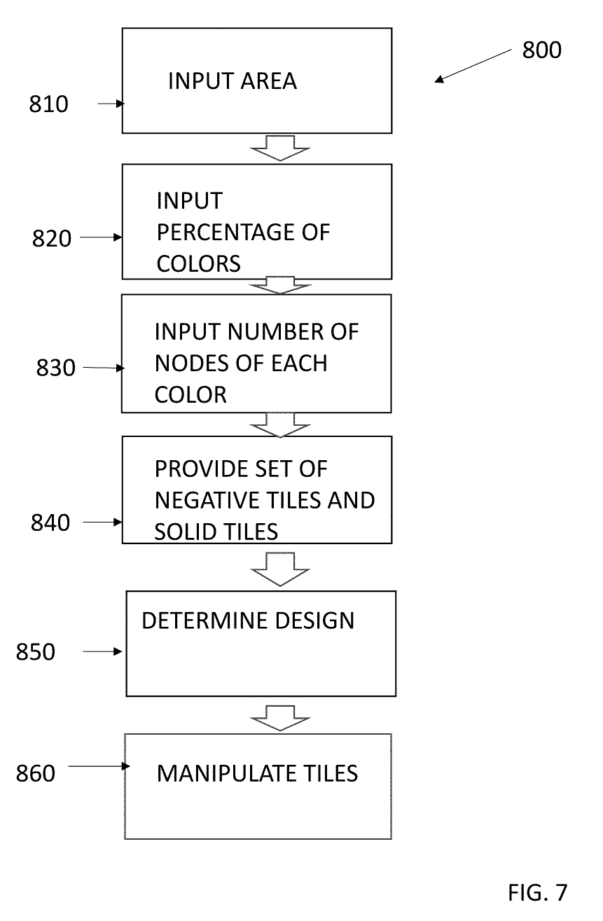

FIG. 7 illustrates method 800 according to the invention wherein an individual may customize a floor covering pattern for a desired room configuration utilizing the systems as described above. As shown in FIG. 7 at step 810 an individual may identify the area size which the floor covering will be utilized. At step 820 the individual may identify the room parameters associated with a particular room which the individual would like to construct a respective floor covering pattern utilizing the associated tiles of the invention. As noted, the respective tile designs enable a continuous curve to be constructed throughout a floor area. In designing the floor design, the individual may utilize the room components such as bed, desk, bureau, couch, and other room furniture and accessories as parameters such as door openings and windows within the room which the design will work around and be incorporated with. At step 830, an individual may identify the respective colors they would like to be present in the overall configuration. The system at step 840 provides the individual user with the respective negative tile sets with the first and second tile having the negative color tone pattern and the third and fourth solid tiles of the respective two-color tones as identified at Step 830. At step 850 the individual manipulates the respective tiles to create various designs. Once a design is established by the individual, the system at step 860 identifies the respective quantity of each tile needed to replicate the desired floor covering pattern.

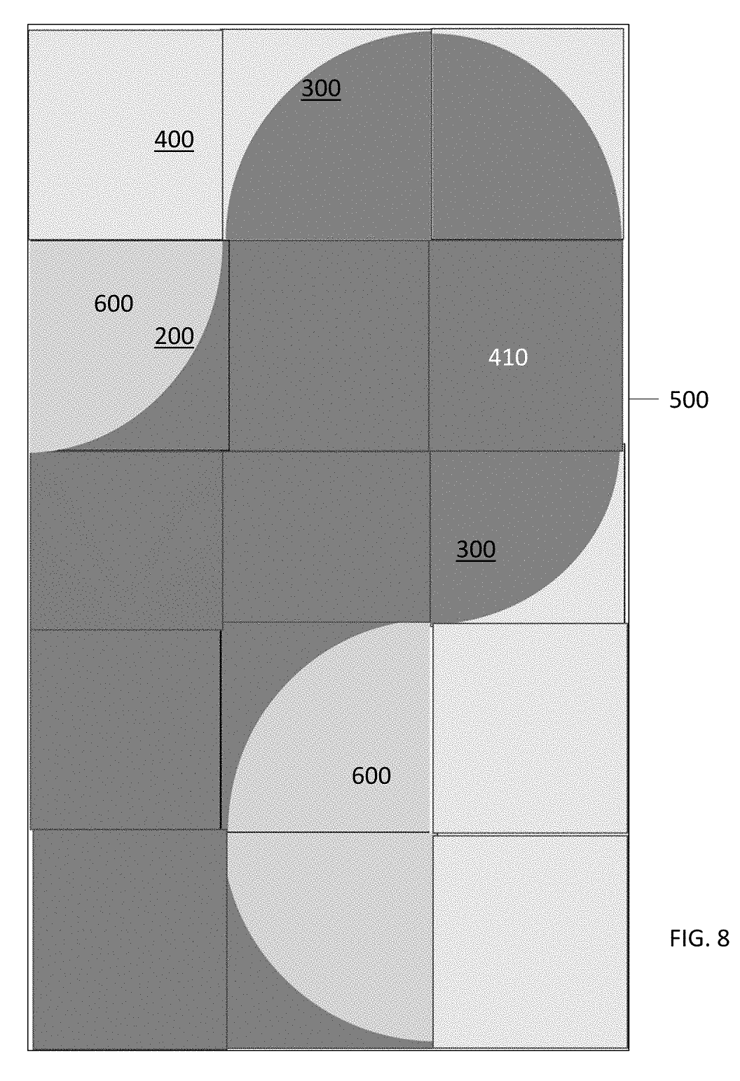

FIG. 8 illustrates a respective pattern which may be produced utilizing the method of 800. utilizing first and second tiles 200 and 300 respectively in combination with solid tiles 400 and 410. FIG. 8 illustrates a three by five configuration utilizing three first tiles 200, three second tiles 300, three third tiles 400 and five fourth tiles 410. Node 500 is created from a continuous line which originates with the curved line which is the second portion of tile 200 and continues with the curved line which defines the first portion of tile 300 and continues likewise through another tile 300, solid tile 410, another tile 300, another solid tile 410, another tile 300, and two tiles 200. The curved nature of design is unique and may be manipulated utilizing additional tile configurations. The interrelationship of the negative tiles and solid tiles enables a continuous curved pattern to be presented throughout the entire area. In this configuration, a single large node is presented, two smaller nodes of the negative tone are also produced due to the interrelationship of the respective tiles. In the preferred embodiment, once this pattern is produced, the system will generate how many tile components are necessary for the design. For instance, the end user may just produce a design without knowing what specific tile configurations would produce such a design.

As show in FIG. 8, a multi-curvilinear design may be constructed which may give the appearance of land and water should the respective tonal colors of the tiles be green or brown and blue. For instance, if the first portion of tile 200 was green or blue and the background or second portion of the tile 200 was blue, the corresponding tone of the first portion of tile 300 would be blue and the second portion of tile 300 would be correspondingly green or blue. Hence the design as shown in FIG. 8 would provide the appearance of a water body such as a lake surrounded by land or a beach. The multi-curved design can be enlarged utilizing the solid tiles 400 and 410 Of course, other colors may be utilized, for instance the lighter color may be white and the darker color pink.

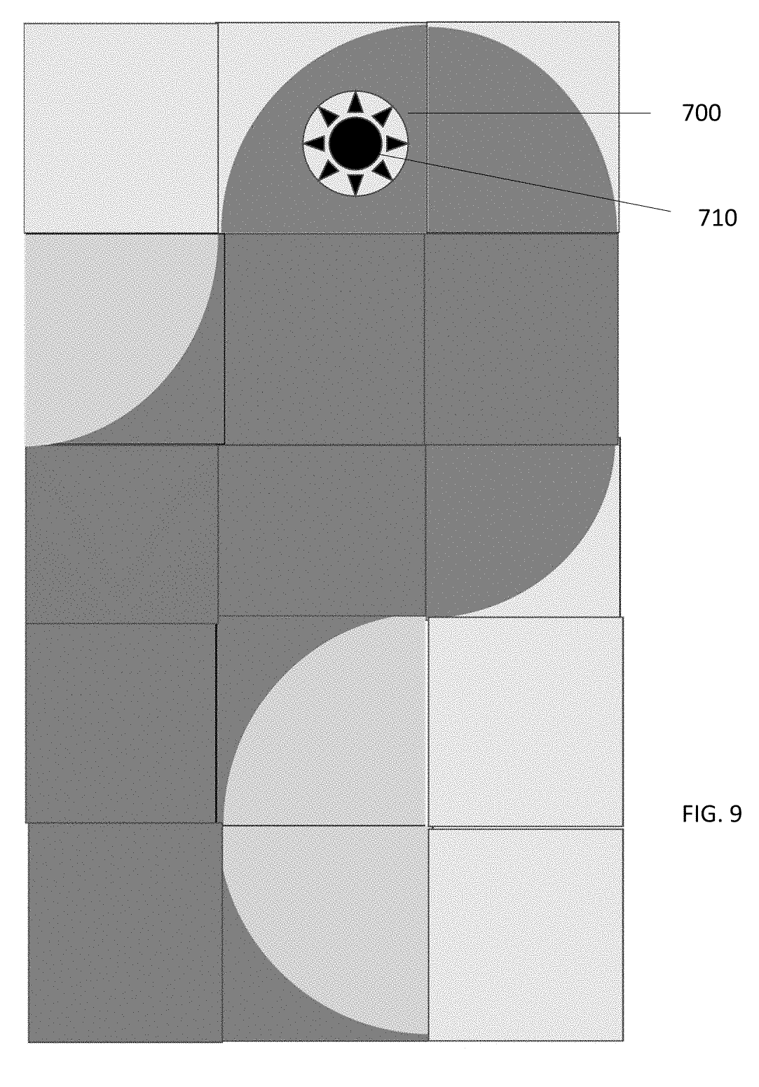

FIG. 9 illustrates a floor covering configuration utilizing the tiles according to the present invention which may be utilized as a putting surface. In this configuration, one of the tiles may be designed to include a cut out section 700 which is adapted to receive a golf ball receiver 710. In the preferred embodiment, golf ball receiver is of the type disclosed in U.S. Pat. No. 5,997,406 issuing on Dec. 7, 1999.

Overall, it may be seen, that a more advantageous system for developing floor covering patterns or configurations may be had utilizing the tile designs of the present invention. By providing a pair of tiles having a negative appearance with respect to each other by exhibiting the same pattern but in reverse tones, multiple configurations may be constructed from a set of tiles. In the preferred embodiment, the set of tiles includes two primary tiles having a primary design of an arc which extends from one edge of the tile to the other edge of the tile wherein the respective edges intersect to form a corner or ninety-degree angle wherein the arc preferably forms a quadrant. The area covered by the arc has a first tone and the area of the tile not covered by the arc, generally the background, has a second tone distinct from the first tone. In the preferred embodiment, the tile consists solely of these two portions and these two tones respectively. The two tiles are negatives of each other.

In the preferred embodiment, the set of tiles includes a first solid tile consisting solely of one of the tones found in the primary tiles and a second solid tile consisting of the alternative tone. With this configuration, four tiles are provided utilizing only two distinct tones. The tiles may be oriented in any rotational position, thereby providing multiple configurations each having a curvilinear portion. Overall, the tiles provide the end user with the ability to be creative in their respective designs and not limited by a pre-fabricated appearance. Additionally, the respective portions of the tiles may be constructed utilizing different components providing different surfaces.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present in v ention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1-12. (canceled)

13. A tile set comprising:
a first tile having a predefined surface area;
said first tile predefined surface area having a first tile portion having a first color tone and a second tile portion having a second color tone, said first and said second portion constituting the entire surface area of said first tile;
said first tile portion having an arcuate profile and said first color tone extending throughout the entire area enclosed by the arcuate profile;
said second tile portion encompassing the remainder of said first tile defining a background and said second color tone being of a distinctive tone than said first color tone; and
a second tile having a predefined surface area;
said second tile predefined surface area having a first tile portion having a first color tone and a second tile portion having a second color tone, said first and said second portion constituting the entire surface area of said second tile;
said first tile portion having an arcuate profile and said first color tone extending throughout the entire area enclosed by the arcuate profile;
said second tile portion encompassing the remainder of said second tile defining a background and said second color tone being of a distinctive tone than said first color tone;
said first color tone of said first tile portion of said first tile being the same color tone as said second tile portion of said second tile and said first color tone of said first tile portion of said second tile being the same color tone as said second tile portion of said first tile;
a third tile having a third tile profile and having a single-color tone which is the same color tone as said first tile portion of said first tile;
a fourth tile having a fourth tile profile and having a single-color tone which is the same color tone as said first tile portion of said second tile and;
said first tile having a first tile portion having an arcuate profile defining an area of said first color tone and said second tile portion having a second color tone has a negative appearance as compared to said second tile having said first tile portion having an arcuate profile defining an area of said color tone identical to the color tone of said second tile portion of said first tile and wherein the second tile portion of the second tile has a color tone identical to the color tone of the first tile portion of the first tile.

14. (canceled)

15. The tile set of claim 13 wherein a hole is defined with in the profile of either said first, second, third or fourth tile.

16. The tile set of claim 15 wherein a ball receiver is received within said hole.
